(19) United States
(12) Patent Application Publication
(10) Pub. No.: US 2022/0051154 A1
(43) Pub. Date: Feb. 17, 2022

(54) METHOD AND APPARATUS FOR MEASURING PLANT TRICHOMES

(71) Applicant: BLOOMFIELD ROBOTICS, INC., Pittsburgh, PA (US)

(72) Inventors: Timothy MUELLER-SIM, Pittsburgh, PA (US); Harjatin BAWEJA, Pittsburgh, PA (US); Tanvir PARHAR, Pittsburgh, PA (US)

(21) Appl. No.: 17/298,731

(22) PCT Filed: Dec. 18, 2019
(86) PCT No.: PCT/US2019/067194

§ 371 Date: Jun. 1, 2021

Related U.S. Application Data
(60) Provisional application No. 62/785,081, filed on Dec. 26, 2018.

(51) Int. Cl. G06Q 10/06; G06Q 50/02; G06K 9/00; G06T 7/00

(52) U.S. Cl. CPC G06Q 10/06312; G06Q 50/02; G06K 9/00657; G06T 2207/30188; G06T 2207/20212; G06T 2207/20084; G06T 7/0012

(57) ABSTRACT

Systems and methods analyze a plant comprising trichomes. The system can include a back-end computer system communicably couplable to an imaging device. The imaging device captures multiple images of the plant at a plurality of different focal distances, combines the multiple images into a composite image having a greater depth of field utilizing focal stacking, and transmits the composite image to the back-end computer system. The back-end computer system identifies the trichomes imaged within the composite image utilizing a machine learning system, determines a property of the identified trichomes, determines a projected harvest time for the plant according to the property, and provides the projected harvest time to a user. The trichomes within the composite image can be identified utilizing a machine learning system.

### PRIORITY

The present application claims priority to U.S. Provisional Patent Application No. 62/785,081, titled METHOD AND APPARATUS FOR MEASURING PLANT TRICHOMES, filed Dec. 26, 2018, the entire disclosure of which is hereby incorporated by reference herein in its entirety.

### BACKGROUND

Various of the embodiments described herein concern agriculture. More particularly, various disclosed embodiments concerning a method and apparatus for measuring plant trichomes in order to, for example, optimize harvest timing.

For some plants, such as marijuana, growers make decisions on when to harvest a crop based at least in part on the plants' trichomes, which are epidermal outgrowths of various kinds. A common type of trichome is a hair. There can be a variety of different plant hairs, such as unicellular or multicellular plant hairs, branched or unbranched plant hairs, and so on. Multicellular hairs may have one or several layers of cells. Further, any of the various types of hairs may be glandular, producing some kind of secretion. In the case of a marijuana plant, trichomes grow the psychoactive chemicals (e.g., THC and CBD) that make marijuana valuable. As they mature, the trichomes of marijuana plants change in color from clear to cloudy to amber. Growers determine peak maturity based on the ratio of these colors of the trichomes on the plants. However, timing a crop harvest to occur at the plants' peak maturity is time-consuming, tedious, and heavily dependent upon the experience of the individual performing the assessment because it requires inspecting the microscopic trichomes of each individual plant. In practice, growers instead simply sample some of the plants within a crop (typically, somewhere within a range of 5-10% of the crop) and then make a decision when to harvest the entire crop based upon the sampled plants. However, even plants within the same crop can mature at different rates based upon genetics and factors associated with each plant's microenvironment. Therefore, harvesting an entire crop based on a sampled subset of the crop can result in some of the plants within the crop being harvested before or after peak maturity. For crops such as marijuana, mistimed harvests typically result in a 10% revenue loss. Further, growers can lose 20-30% of plant productivity due to mismanaged plant threats, even after daily scouting, to such factors as disease, poor nutrition, mold, and pests. Therefore, systems and methods of improving the visualization and analysis of plant trichomes would be highly beneficial so that plants could be analyzed on an individualized basis in a fast and efficient manner. If every single plant within a crop could be analyzed on an individualized basis, harvest times for each individual plant could be optimized and plant threats could be identified and rectified prior to significant amounts of damage being inflicted on a crop.

### SUMMARY

In one general aspect, the present invention is directed to computer-implemented systems and methods for analyzing a plant comprising trichomes. In one embodiment, the system comprises a back-end computer system and an imaging device. The imaging device comprises (i) an imaging assembly that captures images of the plant at multiple different focal distances and (ii) a controller that combines the images into a composite image having a greater depth of field utilizing focal stacking and then transmits the composite image to the back-end computer system. The back-end computer system is programmed to: (a) identify the trichomes imaged within the composite image utilizing a machine learning system; (b) determine a property of the identified trichomes; (c) determine a projected harvest time for the plant according to the property; and (d) provide the projected harvest time to a user.

In various implementations, the imaging device may comprise a display scree that displays the projected harvest time to the user. The back-end computer system may also identify the trichome type, such as clear, cloudy or amber. The property of the identified trichomes that the back-end computer system determines could be a property such as the count, density and/or size of the trichomes.

The computer-implemented comprises, in one embodiment: (i) receiving, by the computer system, a plurality of images of the plant at the multiple different focal distances; (ii) combining, by the computer system, the plurality of images into a composite image having a greater depth of field utilizing focal stacking; (iii) identifying, by the computer system, the trichomes imaged within the composite image utilizing a machine learning system; (iv) determining, by the computer system, the property of the identified trichomes utilizing the machine learning system; (v) determining, by the computer system, the projected harvest time for the plant according to the property; and (vi) providing, by the computer system, the projected harvest time to the user.

Embodiments of the present invention provide many useful advantages over currently available systems for analyzing trichomes of a plant. For example, embodiments of the present invention provide an accurate, easy-to-use and inexpensive way for a harvester to determine—on a plant-by-plant basis if desired—the opportune time to harvest his/her trichome plants. These and other benefits of the present invention will be apparent from the description below.

### FIGURES

The features of various aspects are set forth with particularity in the appended claims. The various aspects, however, both as to organization and methods of operation, together with further objects and advantages thereof, may best be understood by reference to the following description, taken in conjunction with the accompanying drawings as follows.

FIG. 1 is a diagram of a plant analysis system, in accordance with at least one aspect of the present disclosure.

FIG. 2 is a diagram of an imaging device for the plant analysis system, in accordance with at least one aspect of the present disclosure.

FIG. 3 is a diagram of a graphical user interface (GUI) for the plant analysis system, in accordance with at least one aspect of the present disclosure.

FIG. 4 is a logic flow diagram of a process for analyzing trichomes, in accordance with at least one aspect of the present disclosure.

FIG. 5 is a block diagram of a machine learning system programmed to characterize trichomes of an imaged plant, in accordance with at least one aspect of the present disclosure.

### DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such herein.

Various aspects described herein provide systems and methods utilizing computer vision and AI to determine projected harvest times and other data regarding plants based upon the arrangement and types of trichomes on the plant. Accordingly, the described systems and methods can solve issues associated with ascertaining the appropriate harvest times for plants by imaging them, addressing the harvest timing issue for trichomes by using grower knowledge to grow the perfect plant, and applying it to thousands of or more plants. The systems and methods of the present invention can support harvest timing and other potential applications (e.g., to improve yields) for peak THC and CBD, and thereby enable product consistency.

Research in high throughput phenotyping has provided algorithms for the extraction and detection of specific plant features, as well as signs of disease, pest, molds, and poor nutrition. In some aspects, these algorithms can be leveraged to detect the same features in Cannabis and correlate the impact of nutrition cycles on the plant's production. In some aspects, the algorithms can be retrained by having a human manually annotate images with information about trichome location and color. These labeled images can then be used to train a neural network or another machine learning system to detect trichomes or other features on other types of plants. As used herein, “training” is defined as an algorithm that updates internal network parameters so that the network output most closely approximates the labels in the training data.

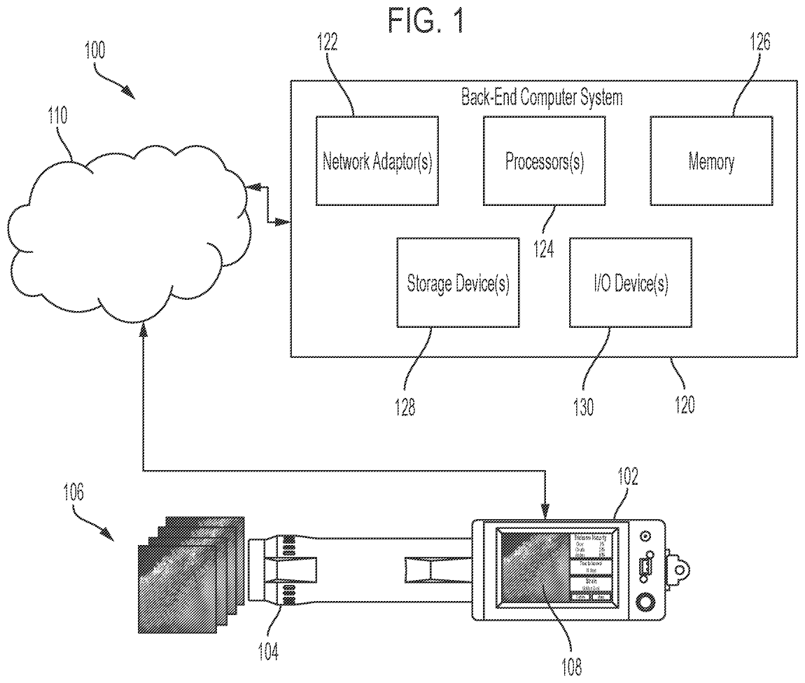

The present disclosure is directed generally towards a system for capturing images of plants and analyzing the captured images to calculate plant properties to assist users in determining when to harvest the plant. An example plant analysis system 100 is shown in FIG. 1. The plant analysis system 100 includes an imaging device 102 that is communicably connectable to a back-end computer system 120 via a data network 110, which may comprise a LAN, WAN, the Internet, etc. The imaging device 102 may be, for example, in wireless communication with a device that is connection to the data network 110, such as to a router or wireless access point via a WiFi data link or a to a mobile device (e.g., smartphone, tablet computer, laptop, etc.) via a Bluetooth, Bluetooth Low Energy, Zigbee, MQTT, or Mosquitto communication link, for example. The imaging device 102 can be programmed to capture, process, and transmit images 106 of the plants with trichomes being assessed to the back-end computer system 120. The back-end computer system 120 can in turn be programmed to analyze plant features within the images 106 and calculate parameters associated with the plant features to assist users in determining whether to harvest the plants. The analysis and/or parameter determinations can be performed using, at least in part, machine learning.

The plant analysis system 100 generally functions by, for example, capturing a series of images of a plant or portions thereof at different focus distances, combining the captured images using focus stacking techniques to ensure the appropriate sharpness for the analyzed images, analyzing the focus stacked images to identify particular plant features, and then providing the user with various parameters and/or recommendations based on the identified plant features. Plants can be analyzed according to a number of different features; however, the particular example described herein is in the context of trichomes. In some aspects, the plant analysis system 100 can employ computer vision and artificial intelligence algorithms to detect and count clear, cloudy, and amber trichomes. The ratio of clear, cloudy, and amber trichomes can be used to determine flower maturity and predict an optimum harvest date. In some aspects, an imaging device 102 can be utilized to scan the entire plant canopy to detect threats and optimize plant nutrition for peak production. In some aspects, the plant analysis system 100 can be further configured to include chemical analysis, which can support harvest timing and other potential applications (e.g., to improve yields) for peak THC and CBD, and thereby enable product consistency.

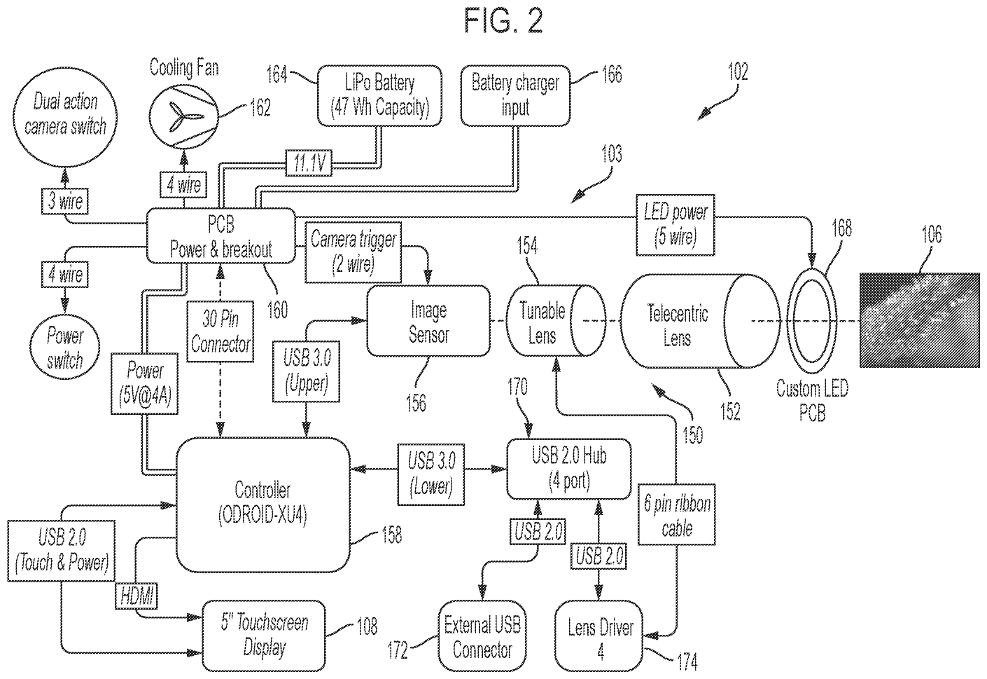

FIG. 2 is a block diagram of an example of an imaging device 102 for use with the plant analysis system 100. The imaging device 102 can include an imaging assembly 103, which can in turn include an image sensor 156 coupled to a lens assembly 150. The lens assembly 150 can be designed to capture images 106 at multiple different focus distances. The lens assembly 150 can include, for example, a telecentric lens 152 optically coupled to a tunable lens 154. The image sensor 156 and lens assembly 150 can be embodied as, e.g., components of a five megapixel global shutter camera. The lens assembly 150 can be controlled by the imaging device 102 to focus at different depths within the image field of view, representing different locations within the imaged plant via images taken at different focal distances. As such, the lens assembly 150 is focused to capture images with a focal center along different points of the trichome(s), thus imaging sharply at different locations along the trichome(s). Further, the imaging device 102 can be designed to capture images at a sufficient speed for the images to be usable in focal stacking techniques (e.g., one image per 1/10th of a second). The imaging device 150 can further include a controller 158, computer (e.g., an ODROID-XU4), microcontroller, system on a chip (SoC) and/or other hardware, software, or firmware components programmable to perform the various image capture, focus stacking, data transmission, display control, and other tasks described herein. The imaging device 102 can further include a display 108 (e.g., a touchscreen display) coupled to the controller 158 for displaying the images captured by the image sensor 156, calculated parameters, user recommendations, and other data. In FIG. 1, the display 108 is illustrated as integral to the imaging device 102. In other examples, the display 108 can be separate from or otherwise communicably connected to the imaging device 102, such as a display screen of a tablet computer or smartphone connected to (e.g., via a wireless data link) the imaging device 102.

The imaging device 102 can include a variety of other hardware and/or software components. For example, the image sensor 156 and/or the controller 158 can be coupled to or supported by a PCB 160. The PCB 160 can further support a cooling fan 162 configured for temperature control of the imaging device 102, a battery 164 (e.g., a LiPo battery), and a battery charger input 166 configured to receive an electrical connector for charging the battery 164. The computer 158 can further be coupled to a port assembly 170 (e.g., a USB 2.0 four port hub). The port assembly 170 can be configured to be coupled to an external USB connector 172 and/or a lens driver 174 (e.g., an Optotune Lens Driver 4) for controlling the tunable lens 154 of the lens assembly 150. The imaging device 102 can further include an LED PCB 168 configured to provide illumination for capturing an image 106 via the image sensor 156.

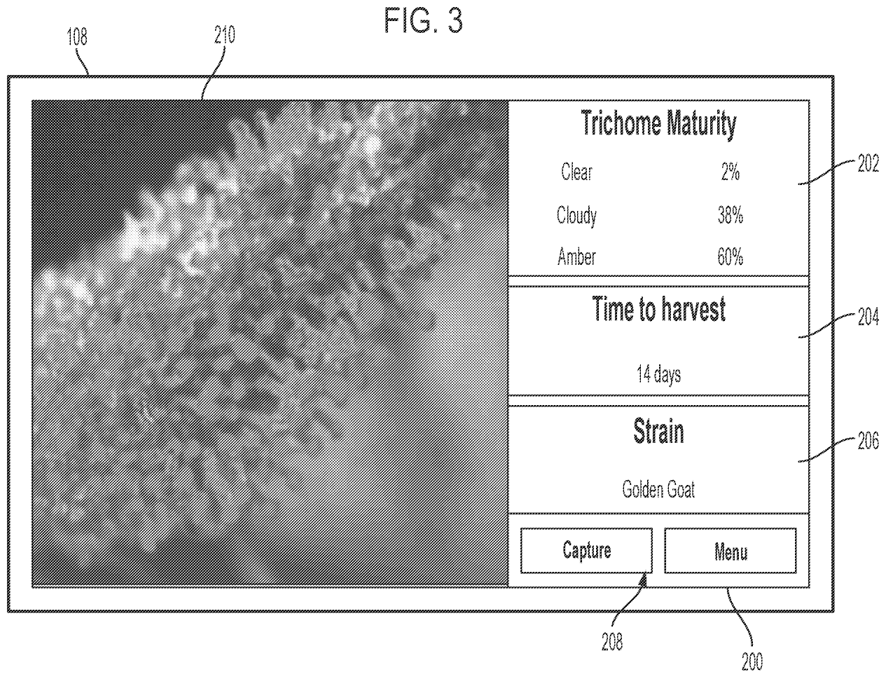

As shown in FIG. 3, the display 108, as controlled by the controller 158, can provide a GUI 200 for receiving commands from and relying information to users. In one aspect, the GUI 200 can include a variety of calculated parameters and/or user recommendations that are provided based on the analysis of the captured images. In the example shown in FIG. 3, the GUI 200 can include maturity data 202, harvest data 204, and plant type data 206. As noted above, in one particular implementation, the plant analysis system 100 can be designed to detect and count clear, cloudy, and amber trichomes, as indicated by the maturity data 202. The counts of the different trichome types can in turn be utilized to determine ideal harvest time, as indicated by the harvest data 204 and as is described in greater detail below. The harvest data 204 can include a specific projected ideal harvest data or a projected number of days until an ideal harvest day, as shown in FIG. 3, for example. The GUI 200 can further provide additional information, including plant type data 206 (e.g., strain) that is determined based upon the characterized plant features, and/or the focus stacked image 210 generated from the captured images. The GUI 200 can further provide user controls 208, such as “Capture,” which causes the imaging device 102 to capture a set of images; “Menu,” which causes the GUI 200 to return to a menu or home screen; and so on.

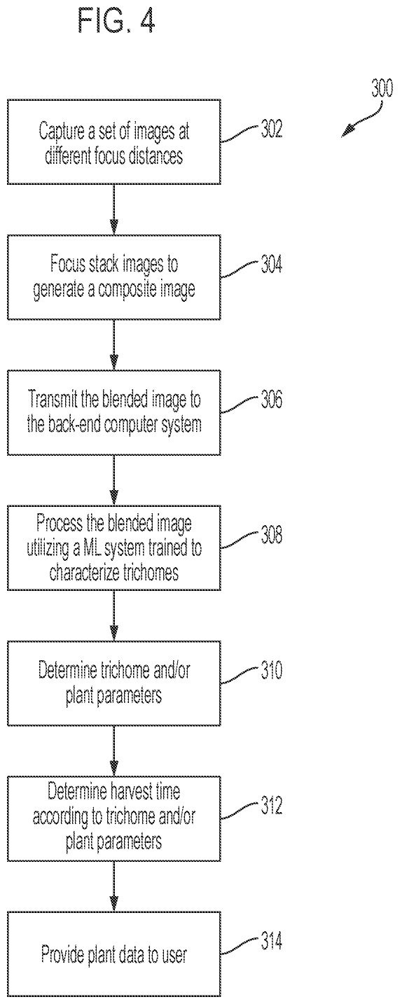

The plant analysis system 100 can execute a process to capture images of a plant, process the captured images using a machine learning classifier to identify features of the plant (e.g., trichomes), and then calculate statistics associated with the plant (e.g., trichome density), determine properties of the plant (e.g., time to ideal harvest), and/or provide recommendations to users based on the identified features. An example of such a process 300 is illustrated in FIG. 4. In the following description of the process 300, reference should also be made to FIGS. 1 and 2. The following example process 300 is described as being executed across both the imaging device 102 and the back-end computer system 120; however, in other aspects, the process 300 can be executed solely by the imaging device 102 or by other combinations of other computer systems and other such devices. Accordingly, the process 300 can be embodied as a set of computer executable instructions stored in a memory (e.g., the memory 126 of the back-end computer system 120 and/or the memory of the imaging device controller 158) that, when executed by a processor (e.g., the processor(s) 124 of the back-end computer system 120 and/or the processor(s) of the imaging device controller 158) cause the back-end computer system 120 and/or the imaging device 102 to perform the illustrated process 300 or steps thereof.

At a first step 302, the imaging device 102 can capture a series of images at different focus distances. As noted above, the imaging device 102 can capture the images using a five megapixel camera fitted with a tunable lens 154 and a telecentric lens 152, for example. At a second step 304, the imaging device 102 can generate a composite image (which can also be referred to as a “hyperfocal image”) from the captured images (e.g., five images) using focal stacking techniques. Focal stacking generally functions by registering the captured images 106 so that they all have the same features in the same places, identifying the high-contrast regions of each image 106 in the stack, and then stitching together a composite image that uses the highest contrast region from the available images in the stack for every part of the image. Capturing multiple images and using focal stacking techniques is advantageous because it provides a greater depth of field (DOF) to the resulting image, which in turn can improve the performance of machine learning and algorithmic analysis of the image.

At a third step 306, the imaging device 102 can transmit the composite image to the back-end computer system 120 for further processing thereby. It should be noted that in other examples, this step could be omitted and the subsequent processing and analysis steps could be performed on-board the imaging device 102.

At a fourth step 308, the back-end computer system 120 can process the received composite image using a machine learning system trained to identify and/or characterize plant structures, such as trichomes or components thereof (e.g., heads, stalks, and/or pistules of trichomes). The machine learning system can further be trained to identify and distinguish between different types of trichomes, in addition to properties associated with individual trichomes. For example, the machine learning system can be trained to classify identified trichomes into clear, cloudy, or amber classification categories, as shown in the GUI 200 of FIG. 3. By distinguishing between different types of trichomes, the back-end computer system 120 can make determinations regarding the health of the plant, the projected ideal harvest time for the plant, and so on. The machine learning system can be trained using supervised or unsupervised machine learning techniques.

At a fifth step 310, the back-end computer system 120 can determine or calculate parameters associated with the identified trichomes or other plant structures. The parameters can include counts, densities, or ratios of the various trichome types that the classifier executed by the back-end computer system 120 has been trained to distinguish. In the example shown in FIG. 3, the back-end computer system 120 has determined that of the trichomes shown in the composite image 210, 60% are of the amber type, 38% are of the cloudy type, and 2% are of the clear type. The back-end computer system 120 can also determine or calculate information pertaining to the plant as a whole. Referring again to the example shown in FIG. 3, the back-end computer system 120 has determine that the plant shown in the composite image 210 is a strain called “Golden Goat” based on the characteristics and/or arrangement of the trichomes or other plant structures identified by the classifier.

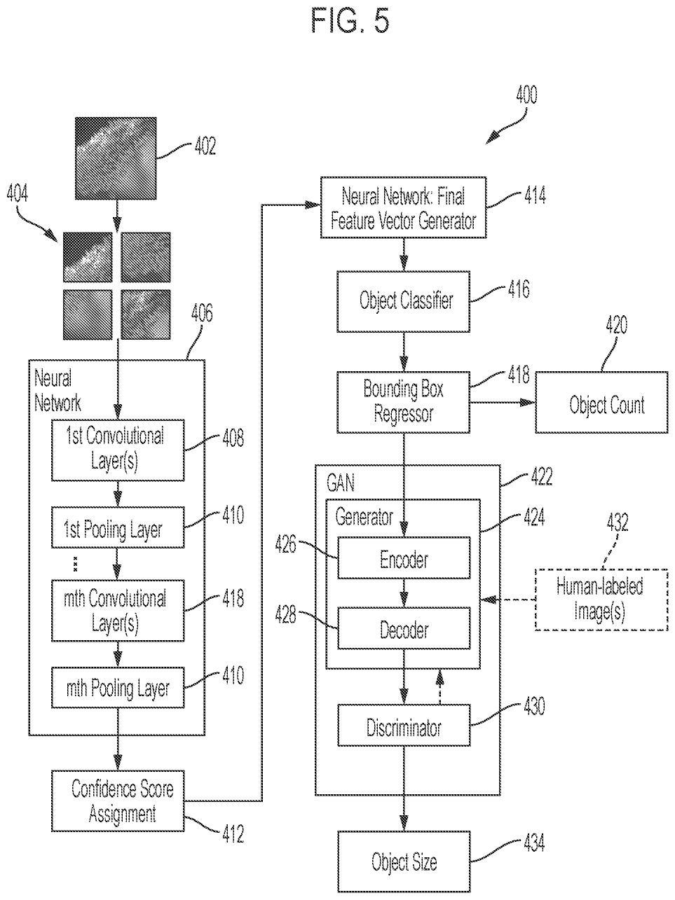

As one example, the back-end computer system 120 can be programmed to execute a machine learning system 400 as illustrated in FIG. 5 to implement the fourth step 308 and the fifth step 310 of the process 300. The machine learning system 400 can be programmed to identify, count, and/or characterize objects, such as trichomes, within the images captured at the first step 302 and further determine properties associated with the characterized objects. The machine learning system 400 can be embodied as or include a classifier trained to identify and characterize trichomes located within an image provided thereto. In one example implementation, the machine learning system 400 can process a composite image 402 received at the third step 306 from the imaging device 102 to identify plant structures, such as trichomes or components thereof contained within the composite image 402. In one aspect, the machine learning system 400 can be programmed to initially break each received composite image 402 into n (e.g., nine) image parts 404. Optionally, edge pixels of the received images can be removed into the images being broken into the n image parts. The machine learning system 400 is further programmed to pass the image parts 404 to a neural network 406 comprising m sets of one or more convolutional layers 408 and a pooling layer 410 that receives the output of the corresponding convolutional layers 408. Each of the convolutional layers 408 can have a number of filters that have a window size of a particular number of pixels (e.g., 3×3 pixels). Accordingly, each of the pooling layers 410 can have a receptive field of a particular number of pixels (e.g., 2×2 pixels) that can be different than the window size of the corresponding convolutional layers 408. The convolutional layers 408 can receive the output of a pooling layer 410 from a preceding set, except the first set of convolutional layers 408, which receives the images parts 404 as input. The m sets of corresponding convolutional layers 408 and pooling layers 410 can have the same or different numbers of filters, window sizes, and/or receptive fields, as appropriate for the layer type. Each of the layers 408, 410 can utilize rectified linear units (ReLUs) or other types of activation functions for its nodes.

The resulting output of the processing through the neural network 406 is a feature cuboid for the input composite image 402. The back-end computer system 120 can be further programmed to classify each location within the feature map as either an object (e.g., a trichome or component thereof) or a non-object by defining an anchor box at each location of the effective receptive fields of various sizes and aspect ratios (e.g., 1:1, 1:2, 3:1, and so on). The back-end computer system 120 can be programmed to assign a confidence score 412 to each of these snipped feature masks according to whether it contains an object or not. Further, the back-end computer system 120 can be programmed to process the top k (e.g., 2,500) highest scoring candidate feature map snippets through a neural network 414 to generate a final feature vector, which is passed through an object classifier 416 and bounding box regressor 418. The output of the object classifier 416 and the bounding box regressor 418 is N bounding boxes, each with a class label associated with them. Based on the N labeled bounding boxes, the back-end computer system 120 can be programmed to output an object count 420. In an implementation where the machine learning system 400 is programmed to characterize trichomes, the object count 420 can thus correspond to the number of trichomes or components thereof identified by the machine learning system 400 within the composite image 402. Accordingly, the described machine learning system 400 localizes and classifies objects of interest within a composite image 402 provided as input to the back-end computer system 120 by the imaging device 102.

In one aspect, in addition to counting the objects as described above, the back-end computer system 120 can be programmed to characterize additional properties of the characterized objects within the composite image 402, such as the size of the individual instances of the objects detected within the composite image 402. In one example implementation, the back-end computer system 120 can be programmed to implement a conditional Generative Adversarial Network (GAN) 422. The GAN 422 can include a generator 424 and a discriminator 430. The generator 424 can further include an encoder 426 and a decoder 428. The encoder 426 can include a set of convolutional layers having a filter size of a particular number of pixels (e.g., 4×4 pixels), a stride of a number of pixels (e.g., 2×2 pixels) that can differ from the filter size, and various combinations or ReLU, tan h, or other activations functions for its nodes. The decoder 428 can mirror the number and types of filters in each layer of the encoder 426. The decoder 428 can be programmed such that each layer in the decoder 428 receives as input the feature map from a previous layer concatenated with the feature map of a corresponding layer from the encoder 426 in the form of a skipped connection. This ensures no loss of granularity. Each layer of the decoder 428 then up samples its input using the defined filter and stride sizes. Accordingly, the final output of the generator 424 is the same size as the input to the generator 424. Further, the discriminator 430 can be programmed to receive (i) a concatenation of the original composite image 402 received by the machine learning system 400 and the output of the generator 424 and/or (ii) a concatenation of the original composite image 402 and a human-labeled image 432. The discriminator 430 is programmed to encode these images with an architecture that can be similar to an architecture of an initial portion of the encoder 426. The back-end computer system 120 can be programmed to generate a feature vector from the feature map output by the discriminator 430, such as by passing the feature map resulting from the discriminator 430 through a convolutional layer having a filter size of 1×1. During training, the back-end computer system 120 can then classify the feature vector corresponding to the transformed image as either being a human-labeled image or an image that was semantically segmented by the generator 424. The back-end computer system 120 can then update the weights and/or other learned parameters of the discriminator 430 based on the classification error (e.g., via back propagation), as determined by a defined cost or loss function. Accordingly, the back-end computer system 120 can train the generator 424 based on the output of the discriminator 430 and/or the difference between the output discriminator 430 and the target human-labeled image 432. To enhance sample efficiency during the training process, each already localized object instance from the object classifier 416 or other object detection system can be passed through the GAN 422 for a pixel-level, two-way classification. Once trained (i.e., during inference time), the machine learning system 400 can operate without updating learned parameters of the GAN 422, as indicated by the human-labeled images 432 and the connection from the discriminator 430 to the generator 424 being illustrated in phantom. In one aspect, the back-end computer system 120 can combined the resulting segmentation mask with the intrinsic pixel size of the telecentric lens 152 (which can be a known, defined value or received from the imaging device 102) to determine the sizes of the objects (e.g., trichomes) in metric units.

Although the illustrative machine learning system 400 shown in FIG. 5 is configured to output the count 420 and size 434 of the defined objects, the machine learning system 400 or other machine learning architectures can, in other implementations, be configured to determine additional or different properties associated with the objects. For example, the back-end computer system 120 can be programmed to additionally calculate the density of the detected trichomes based upon the trichome count 420 and the size of the area corresponding to the input composite image 402. The machine learning system 400 described herein can be stored in memory 126 or other storage device(s) 128 of the back-end computer system 120 and executed by a processor(s) 124 coupled thereto. Images 106 and other data can be received from the imaging device 102 via the network adapter 122. Likewise, object count 420, object size 434, and other characterized object parameters output by the machine learning system 400 can be provided to the imaging device 102 via the network adapter 122.

Returning to the discussion of the process 300, at a sixth step 312, the back-end computer system 120 can determine the projected ideal harvest time according to the determined trichome and/or plant parameters. The harvest time can be determined according to, for example, the number, types, and/or sizes of the trichomes as defined by logic executed by the back-end computer system 120. The logic can be based upon or modeled according to empirical data gathered from previous harvests. As one example, the logic could include a determination as to whether the ratio of amber to cloudy trichomes exceeds a predefined threshold.

At a seventh step 314, the back-end computer system 120 can provide data associated with the plant from the images 106 captured by the imaging device 102 to the user. The data can be provided via the GUI 200 provided by, for example, the display 108 of the imaging device 102. For example, after completing fourth through sixth steps 308, 310, 312, the back-end computer system 120 can transmit the determined data to the imaging device 102 for display thereon. Such data can include the time to harvest (e.g., in 14 days for the example shown in FIG. 3) determined at the sixth step 312, the determined trichome parameters, the strain of the plant, and so on.

In an illustrative implementation, the systems and methods described herein could be used in the following manner in operation. An agricultural operation can be setup such that each potted plant has a QR tag associated with it that uniquely identifies that plant. Accordingly, users could scan the QR tag associated with a plant so that the system knows which plant is being scanned and then images various locations of the plant (e.g., the top, middle, and bottom), with multiple images per location, utilizing the imaging device 102. The imaging device 102 then generates onboard a composite image having improved DOF for each imaged plant location. The composite images for the various plant locations can then be uploaded from the imaging device 102 to the back-end computer system 120 for analysis thereby. Thereafter, individualized data and/or recommendations can be provided for each plant, allowing the users to determine whether to harvest on a plant-by-plant basis. This system and process represents a marked improvement over conventional techniques because, currently, analyzing the trichomes of each individual plant is so laborious that individuals instead simply determine whether to harvest an entire crop by analyzing the trichomes of a random sampling of 5-10% of the crop. However, this results in some crops being harvested too early to after peak harvest time, which in turn results in depressed crop yields. By allowing users to quickly and efficiently assess plants' health and harvest state by computationally analyzing their trichomes, the presently described systems and methods allows users to analyze an entire crop and thereby make individualized plant harvesting decisions, which in turns allows crop yields to be maximized.

Referring back to FIG. 1, the back-end computer system 120 may be used to implement certain features of various aspects of the system and processes described herein. The back-end computer system 120 can include a server computer, a client computer, a personal computer (PC), a graphical processing unit (GPU), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The back-end computer system 120 can include one or more central processing units and/or CPUs (generally referred to as processor(s) 124), memory 126, input/output device(s) 130 (e.g., a keyboard, pointing device, touch device, and/or display device), storage device(s) 128 (e.g., disk drive), and a network adapter(s) 122 (e.g., network interface) that are connected to an interconnect. The interconnect can include any one or more separate physical buses, point to point connections, or both connected by appropriate bridges, adapters, or controllers. The interconnect, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 126 and storage device(s) 128 are computer-readable storage media that may store instructions that implement at least portions of the various systems and/or processes described herein. In addition, the data structures and message structures may be stored or transmitted via a data transmission medium, e.g. a signal on a communications link. Various communications links may be used, such as the Internet 110, a local area network, a wide area network, or a point-to-point dial-up connection. Thus, computer readable media can include computer-readable storage media, such as non-transitory media, and computer-readable transmission media.

The systems and processes described herein can be implemented as software, firmware, hardware, or combinations thereof. For example, the instructions stored in memory 126 and/or storage device(s) 128 can be implemented as software and/or firmware to cause the processor 124 to carry out the steps or actions described above. In some aspects, such software or firmware may be initially provided to the back-end computer system 120 by downloading it from a remote system, such as via the network adapter(s) 120. In some aspects, the systems and/or processes described herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, and so on.

Various aspects of the subject matter described herein are set out in the following examples.

### Example 1

A system for analyzing a plant comprising trichomes, the system comprising a back-end computer system and an imaging device. The back-end computer system comprises a processor and a memory coupled to the processor. The imaging device comprises (i) an imaging assembly that captures images of the plant at multiple different focal distances and (ii) a controller that combines the images into a composite image having a greater depth of field utilizing focal stacking and then transmits the composite image to the back-end computer system. The back-end computer system is programmed to: (a) identify the trichomes imaged within the composite image utilizing a machine learning system; (b) determine a property of the identified trichomes; (c) determine a projected harvest time for the plant according to the property; and (d) provide the projected harvest time to a user.

### Example 2

A computer-implemented method for analyzing a plant comprising trichomes, the method comprising: (i) receiving, by the computer system, a plurality of images of the plant at the multiple different focal distances; (ii) combining, by the computer system, the plurality of images into a composite image having a greater depth of field utilizing focal stacking; (iii) identifying, by the computer system, the trichomes imaged within the composite image utilizing a machine learning system; (iv) determining, by the computer system, the property of the identified trichomes utilizing the machine learning system; (v) determining, by the computer system, the projected harvest time for the plant according to the property; and (vi) providing, by the computer system, the projected harvest time to the user.

### Example 3

The system of Example 1 or the method of Example 2, where identifying the trichomes comprises identifying a trichome type from a plurality of trichome types in which each of the trichomes is classified. The plurality of trichome types may comprise clear, cloudy, and amber.

### Example 4

The systems/methods of Examples 1-3, where the property comprises a count, density and/or size of the trichomes.

### Example 5

The systems/methods of Examples 1-4, where the machine learning system comprises a neural network trained via supervised learning.

### Example 6

The systems/methods of Examples 1-4, where determining the projected harvest time comprises determining a ratio of amber trichomes to cloudy trichomes within the plurality of trichomes.

### Example 7

The methods of Examples 2-6, further comprising capturing, with an imaging device, the plurality of images of the plant at the plurality of different focal distances.

### Example 8

The methods of Examples 2-7, further comprising harvesting, by the user, the plant around the time provided by the computer system to the user.

The preceding description has set forth aspects of computer-implemented devices and/or processes via the use of block diagrams, flowcharts, and/or examples, which may contain one or more functions and/or operations. As used herein, the terms “step” or “block” in the block diagrams and flowcharts refers to a step of a computer-implemented process executed by a computer system, which may be implemented as a machine learning system or an assembly of machine learning systems. Accordingly, each step or block can be embodied as a set of computer executable instructions stored in the memory of a computer system that, when executed by a processor of the computer system, cause the computer system to perform the described function(s). Each step or block can be implemented as either a machine learning system or as a nonmachine learning system, according to the function described in association with each particular block. Furthermore, each step or block can refer to one of multiple steps of a process embodied by computer-implemented instructions executed by a computer system (which may include, in whole or in part, a machine learning system) or an individual computer system (which may include, e.g., a machine learning system) executing the described step, which is in turn connected with other computer systems (which may include, e.g., additional machine learning systems) for executing the overarching process described in connection with each figure or figures. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

As used in any aspect herein, the term “system” and related terms can refer to a computer-related entity, either hardware, a combination of hardware and software, software, or software in execution.

As used in any aspect herein, an “algorithm” or “process” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the foregoing disclosure, discussions using terms such as “receiving,” “combining,” “identifying,” “determining,” “providing,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A computer-implemented method of analyzing a plant comprising trichomes, the method comprising:
receiving, by a computer system, a plurality of images of the plant at a plurality of different focal distances;
combining, by the computer system, the plurality of images into a composite image having a greater depth of field utilizing focal stacking;
identifying, by the computer system, the trichomes imaged within the composite image utilizing a machine learning system;
determining, by the computer system, a property of the identified trichomes utilizing the machine learning system;
determining, by the computer system, a projected harvest time for the plant according to the property; and
providing, by the computer system, the projected harvest time to a user.

2. The method of claim 1, wherein identifying the trichomes comprises identifying a trichome type from a plurality of trichome types in which each of the trichomes is classified.

3. The method of claim 2, wherein the plurality of trichome types comprises clear, cloudy, and amber.

4. The method of claim 1, wherein the property comprises a count of the trichomes.

5. The method of claim 1, wherein the property comprises a density of the trichomes.

6. The method of claim 1, wherein the property comprises a size of the trichomes.

7. The method of claim 1, wherein the machine learning system comprises a neural network trained via supervised learning.

8. The method of claim 1, determining the projected harvest time comprises determining a ratio of amber trichomes to cloudy trichomes within the plurality of trichomes.

9. The method of claim 1, further comprising capturing, with an imaging device, the plurality of images of the plant at the plurality of different focal distances.

10. The method of claim 1, further comprising harvesting, by the user, the plant around the time provided by the computer system to the user.

11. A system for analyzing a plant comprising trichomes, the system comprising:
a back-end computer system comprising a processor and a memory coupled to the processor; and
an imaging device comprising:
an imaging assembly; and
a controller coupled to the imaging assembly, the controller configured to:
cause the imaging assembly to capture a plurality of images of the plant at a plurality of different focal distances;
combine the plurality of images into a composite image having a greater depth of field utilizing focal stacking; and
transmit the composite image to the back-end computer system;
wherein the memory of the back-end computer system stores instructions that, when executed by the processor, cause the back-end computer system to:
identify the trichomes imaged within the composite image utilizing a machine learning system;
determine a property of the identified trichomes;
determine a projected harvest time for the plant according to the property; and
provide the projected harvest time to a user.

12. The system of claim 11, wherein the imaging device further comprises a display screen configured to display the projected harvest time.

13. The system of claim 11, wherein the instructions, when executed by the processor, cause the back-end computer system to identify a trichome type from a plurality of trichome types in which each of the trichomes is classified.

14. The system of claim 13, wherein the plurality of trichome types comprises clear, cloudy, and amber.

15. The system of claim 11, wherein the property comprises a count of the trichomes.

16. The system of claim 11, wherein the property comprises a density of the trichomes.

17. The system of claim 11, wherein the property comprises a size of the trichomes.

18. The system of claim 11, wherein the machine learning system comprises a neural network trained via supervised learning.

19. The system of claim 11, wherein the instructions, when executed by the processor, cause the back-end computer system to determine the projected harvest time according to a ratio of amber trichomes to cloudy trichomes within the plurality of trichomes.
